(19) United States
(12) Patent Application Publication
(10) Pub. No.: US 2026/0094561 A1
(43) Pub. Date: Apr. 2, 2026

(54) DISPLAY PANEL AND DISPLAY APPARATUS

(71) Applicant: Tianma Advanced Display Technology Institute (Xiamen) Co., Ltd., Xiamen (CN)

(72) Inventor: Yingteng ZHAI, Xiamen (CN)

(21) Appl. No.: 19/342,725

(22) Filed: Sep. 29, 2025

(30) Foreign Application Priority Data
Jun. 30, 2025 (CN) 202510896394.1

(51) Int. Cl. G09G 3/32

(52) U.S. Cl. CPC G09G 3/32; G09G 2310/0267; G09G 2310/0286; G09G 2310/08; G09G 2320/0233; G09G 2320/0247

(57) ABSTRACT

Provided are a display panel and a display apparatus. The display panel includes shift register units, n gating signal lines, and N pixel circuit rows. An output terminal of a driving module in an i-th shift register unit is connected to one input terminal of a driving module in an (i+1)-th shift register unit. The gating module in a shift register unit is configured to receive at least signals from a corresponding driving module and a corresponding gating signal line, and output a control signal. An operating mode of the display panel includes: a pixel circuit row includes at least two light-emitting stages within a first time, wherein a duration of the first time is equal to a duration of one frame time, and a time interval between two adjacent light-emitting stages is t*m, where t is row time, T is one frame time, and m>n.

### CROSS-REFERENCE TO RELATED APPLICATION

The present application claims priority to Chinese Patent Application No. 202510896394.1, filed on Jun. 30, 2025, the content of which is incorporated herein by reference in its entirety.

### TECHNICAL FIELD

The present disclosure relates to the field of display technologies, and in particular, to a display panel and a display apparatus.

### BACKGROUND

The operation of a pixel circuit requires the use of a light-emitting control signal. The effective pulse width of the light-emitting control signal affects the duration of the light-emitting stage, and thus affects the light-emitting time of a sub-pixel. In one type of prior art, a shift register unit that provides a light-emitting control signal is provided with a gating module, and the gating modules in a plurality of shift register units that are cascaded are alternately connected to a plurality of gating signal lines. However, in practice, the effective pulse width of the light-emitting control signal is limited, resulting in the light-emitting duration of the sub-pixel being limited. Simply by increasing the number of triggering times of the gating modules by gating signals tends to cause the problem of display flicker.

### SUMMARY

Embodiments of the present disclosure provide a display panel and a display apparatus to solve the technical problem of display flicker.

In a first aspect, an embodiment of the present disclosure provides a display panel, including: a plurality of shift register units, n gating signal lines, and N pixel circuit rows, where n and N are both positive integers; where a pixel circuit row of the N pixel circuit rows includes a plurality of pixel circuits arranged in a same direction; the plurality of shift register units are cascaded, a shift register unit of the plurality of shift register units includes a driving module and a gating module, and one control terminal of the gating module is connected to an output terminal of the driving module; an output terminal of the driving module in an i-th shift register unit is connected to one input terminal of the driving module in an (i+1)-th shift register unit, where i is a positive integer; the gating module is configured to receive at least a signal output by a corresponding driving module and a signal provided by a corresponding gating signal line, and output a control signal; and an output terminal of the gating module is connected to the plurality of pixel circuits in at least one of the pixel circuit rows; the n gating signal lines include a 1st gating signal line, a 2nd gating signal line, . . . , to an n-th gating signal line arranged in sequence, and the n gating signal lines are alternately connected to the gating modules in the plurality of shift register units; and an operating mode of the display panel includes: the pixel circuit row includes at least two light-emitting stages within a first time, where a duration of the first time is equal to a duration of one frame time, and a time interval between two adjacent light-emitting stages is t*m, where t is row time, and m is a coefficient; and t=T/N, where T is one frame time, m is a positive integer, and m>n.

In a second aspect, based on the same inventive concept, an embodiment of the present disclosure further provides a display apparatus, including the display panel according to any of the embodiments of the present disclosure.

The display panel and the display apparatus provided by the embodiments of the present disclosure have the following beneficial effects: in the embodiments of the present disclosure, the pixel circuit rows are set to include at least two light-emitting stages within a time equal to one frame time, the time interval between two adjacent light-emitting stages is t*m, m is greater than the number n of the gating signal lines, and thus the time interval between two adjacent light-emitting stages is greater than t*n. Such a setting can ensure that in the case where the number of the gating signal lines is determined, the duration of the light-emitting stage is sufficiently long, and the time interval between two adjacent light-emitting stages of the pixel circuit row within the first time is a fixed value. In this way, a light-emitting device driven by the pixel circuit row can emit light at least twice within the first time, and the time interval between the start moments of two adjacent light emissions is equal, enabling the light-emitting device to emit light relatively uniformly within the first time and avoiding the problem of display flicker caused by concentrated light emission within one frame time.

### BRIEF DESCRIPTION OF DRAWINGS

To more clearly illustrate the technical solutions in the embodiments of the present disclosure or the prior art, the accompanying drawings required to be used in the description of the embodiments or the prior art will be briefly introduced below. Apparently, the accompanying drawings in the following description are some embodiments of the present disclosure, and for those of skill in the art, other accompanying drawings can also be obtained based on these drawings without creative efforts.

FIG. 1 is a schematic diagram of a display panel according to an embodiment of the present disclosure;

FIG. 2 is a schematic diagram of a pixel circuit according to an embodiment of the present disclosure;

FIG. 3 is a signal timing diagram according to an embodiment of the present disclosure;

FIG. 4 is another signal timing diagram according to an embodiment of the present disclosure;

FIG. 5 is a signal timing diagram in the related art;

FIG. 6 is a schematic diagram of an operating mode of a display panel according to an embodiment of the present disclosure;

FIG. 7 is a schematic diagram of another display panel according to an embodiment of the present disclosure;

FIG. 8 is a schematic diagram of another display panel according to an embodiment of the present disclosure;

FIG. 9 is another signal timing diagram according to an embodiment of the present disclosure;

FIG. 10 is a schematic diagram of another pixel circuit according to an embodiment of the present disclosure;

FIG. 11 is another signal timing diagram according to an embodiment of the present disclosure;

FIG. 12 is a schematic diagram of another operating mode of a display panel according to an embodiment of the present disclosure;

FIG. 13 is a schematic diagram of another operating mode of a display panel according to an embodiment of the present disclosure;

FIG. 14 is a schematic diagram of another operating mode of a display panel according to an embodiment of the present disclosure;

FIG. 15 is a schematic diagram of another operating mode of another a display panel according to an embodiment of the present disclosure;

FIG. 16 is another signal timing diagram according to an embodiment of the present disclosure;

FIG. 17 is another signal timing diagram according to an embodiment of the present disclosure;

FIG. 18 is a schematic diagram of a shift register unit according to an embodiment of the present disclosure;

FIG. 19 is another signal timing diagram according to an embodiment of the present disclosure;

FIG. 20 is another signal timing diagram according to an embodiment of the present disclosure; and

FIG. 21 is a schematic diagram of a display apparatus according to an embodiment of the present disclosure.

### DESCRIPTION OF EMBODIMENTS

To make the objectives, technical solutions, and advantages of the embodiments of the present disclosure clearer, the technical solutions in the embodiments of the present disclosure will be described clearly and completely below in conjunction with the accompanying drawings in the embodiments of the present disclosure. Apparently, the described embodiments are part of the embodiments of the present disclosure, rather than all the embodiments. Based on the embodiments of the present disclosure, all other embodiments obtained by those of ordinary skill in the art without creative efforts shall fall within the protection scope of the present disclosure.

The terms used in the embodiments of the present disclosure are only for the purpose of describing specific embodiments, and are not intended to limit the present disclosure. The singular forms “a/an”, “said” and “the” used in the embodiments of the present disclosure and the appended claims are also intended to include the plural forms, unless the context clearly indicates otherwise.

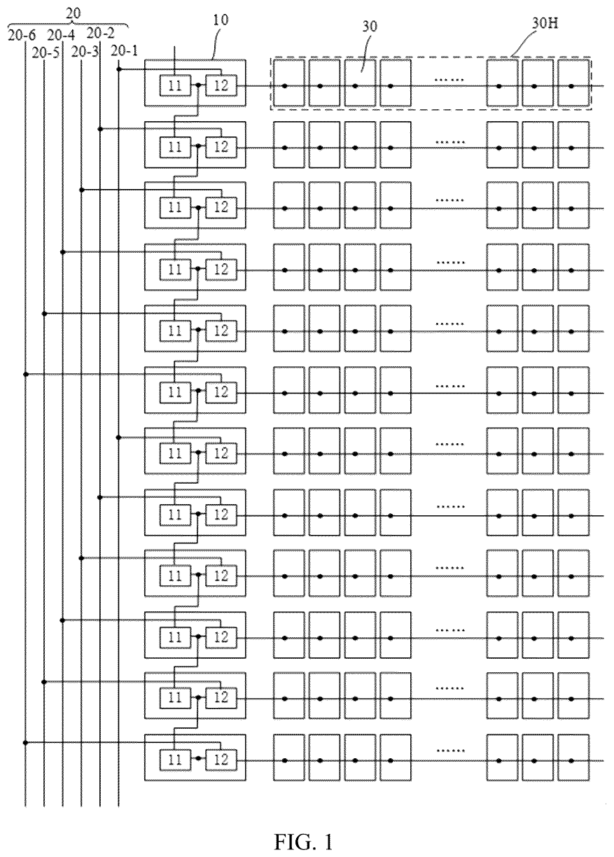

FIG. 1 is a schematic diagram of a display panel according to an embodiment of the present disclosure. As shown in FIG. 1, the display panel includes a plurality of shift register units 10, n gating signal lines 20, and N pixel circuit rows 30H, where n and N are both positive integers; and the pixel circuit row 30H includes a plurality of pixel circuits 30 arranged in a same direction.

The plurality of shift register units 10 are cascaded. The shift register unit 10 includes a driving module 11 and a gating module 12. A control terminal of the gating module 12 is connected to an output terminal of the driving module 11; the output terminal of the driving module 11 in an i-th stage shift register unit 10 is connected to an input terminal of the driving module 11 in an (i+1)-th stage shift register unit 10, where i is a positive integer; the gating module 12 is configured to receive at least a signal output by the driving module 11 and a signal provided by the gating signal line 20, and output a control signal; and an output terminal of the gating module 12 is connected to the plurality of pixel circuits 30 in at least one pixel circuit row 30H. That is, the output terminal of the gating module 12 provides the control signal to the pixel circuits 30. The embodiments of the present disclosure do not limit the specific structures of the driving module 11 and the gating module 12, where the driving module 11 is a structure capable of implementing a signal shifting function, and the gating module 12 is a structure capable of implementing signal gating. The structures of the driving module 11 and the gating module 12 will be illustrated with examples in the following related embodiments.

The n gating signal lines 20 include a first gating signal line 20-1, a second gating signal line 20-2, . . . , to an n-th gating signal line 20-n arranged in sequence, and the n gating signal lines 20 are alternately connected to the gating modules 12 in the plurality of shift register units 10 that are cascaded. That is, the plurality of shift register units 10 that are cascaded take n as a cycle, and n shift register units within one cycle are sequentially connected to the n gating signal lines 20. FIG. 1 is illustrated with n=6. It can be understood that, in the display panel, the shift register unit 10 driving a first pixel circuit row 30H and the shift register unit 10 driving a 7th pixel circuit row 30H (i.e., an (1+n)-th pixel circuit row 30H) are connected to the first gating signal line 20-1; the shift register unit 10 driving a second pixel circuit row 30H and the shift register unit 10 driving an 8th pixel circuit row 30H (i.e., an (2+n)-th pixel circuit row 30H) are connected to the second gating signal line 20-2; and so on.

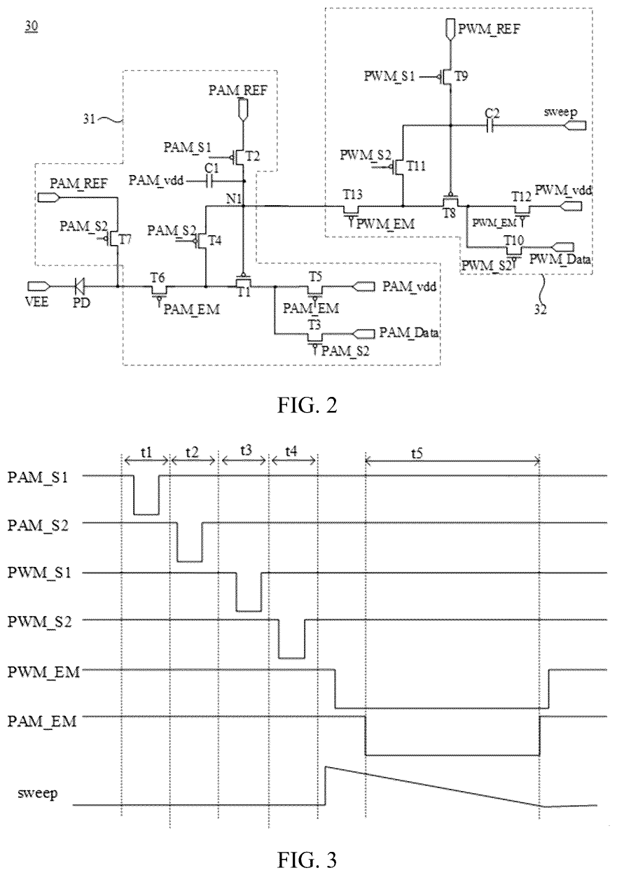

FIG. 2 is a schematic diagram of a pixel circuit according to an embodiment of the present disclosure. FIG. 3 is a signal timing diagram according to an embodiment of the present disclosure, and the pixel circuit provided in FIG. 2 may be driven by using the signal timings provided in FIG. 3.

As shown in FIG. 2, the pixel circuit 30 includes a first driving circuit 31 and a second driving circuit 32. The first driving circuit 31 is configured to control the amplitude of a driving current provided to a light-emitting device PD based on a first data voltage PAM-data, and the second driving circuit 32 is configured to control the duration of the driving current provided to the light-emitting device PD based on a second data voltage PWM-data and a sweep signal sweep. The first driving circuit 31 is a pulse amplitude modulation (PAM) circuit, and the second driving circuit 32 is a pulse width modulation (PWM) circuit. The light-emitting device PD is a light-emitting diode (LED), such as a Micro LED or a Mini LED.

The first driving circuit 31 includes a first driving transistor T1, a first gate reset transistor T2, a first data writing transistor T3, a first compensation transistor T4, a first control transistor T5, a second control transistor T6, an electrode reset transistor T7, and a first capacitor C1. The first control transistor T5 is connected between a first power supply voltage PAM-vdd and a first electrode of the first driving transistor T1, and the second control transistor T6 is connected between a second electrode of the first driving transistor T1 and the light-emitting device PD. The first driving transistor T1 is configured to generate the driving current under the control of its gate voltage, and a gate of the first driving transistor T1 is connected to a first node N1. The first data writing transistor T3 is connected to the first electrode of the first driving transistor T1, the first compensation transistor T4 is connected to the second electrode and the gate of the first driving transistor T1, the first gate reset transistor T2 is connected to the gate of the first driving transistor T1, the electrode reset transistor T7 is connected to a first electrode of the light-emitting device PD, the second control transistor T6 is also connected to the first electrode of the light-emitting device PD, and a second electrode of the light-emitting device PD is connected to a second power supply voltage VEE. A gate of the first gate reset transistor T2 is connected to a scan signal PAM-S1; and a gate of the first data writing transistor T3, a gate of the first compensation transistor T4 and a gate of the electrode reset transistor T7 are connected to a scan signal PAM-S2. A gate of the first control transistor T5 and a gate of the second control transistor T6 are connected to a light-emitting control signal PAM-EM. The first gate reset transistor T2 and the electrode reset transistor T7 receive a reset signal PAM-REF, respectively. In some other implementations of the present disclosure, the electrode reset transistor T7 may also receive a constant voltage signal, and the voltage value of the constant voltage signal is different from the voltage value of the reset signal PAM-REF.

The second driving circuit 32 includes a second driving transistor T8, a second gate reset transistor T9, a second data writing transistor T10, a second compensation transistor T11, a third control transistor T12, a fourth control transistor T13, and a second capacitor C2. The second capacitor C2 is a storage capacitor in the second driving circuit 32. The third control transistor T12 is connected between a third power supply voltage PWM-vdd and a first electrode of the second driving transistor T8, and the fourth control transistor T13 is connected between a second electrode of the second driving transistor T8 and the first node N1. The second data writing transistor T10 is connected to the first electrode of the second driving transistor T8, the second compensation transistor T11 is connected to the second electrode and a gate of the second driving transistor T8, and the second gate reset transistor T9 is connected to the gate of the second driving transistor T8. A first electrode plate of the second capacitor C2 is connected to the gate of the second driving transistor T8, and a second electrode plate of the second capacitor C2 is connected to the sweep signal sweep. A gate of the second gate reset transistor T9 is connected to a scan signal PWM-S1, and a gate of the second data writing transistor T10 and a gate of the second compensation transistor T11 are connected to a scan signal PWM-S2. A gate of the third control transistor T12 and a gate of the fourth control transistor T13 are connected to a light-emitting control signal PWM-EM. The second gate reset transistor T9 receives a reset signal PWM-REF.

The operation process of the pixel circuit 30 is described in conjunction with FIG. 3. During a period t1, the scan signal PAM-S1 provides an enable signal, and the first gate reset transistor T2 is turned on to reset the first node N1. During a period t2, the scan signal PAM-S2 provides an enable signal, the first data writing transistor T3 and the first compensation transistor T4 are turned on to write the first data voltage PAM-data to the first node N1. During a period t3, the scan signal PWM-S1 provides an enable signal, and the second gate reset transistor T9 is turned on to reset the gate of the second driving transistor T8. During a period t4, the scan signal PWM-S2 provides an enable signal, the second data writing transistor T10 and the second compensation transistor T11 are turned on to write the second data voltage PWM-data to the gate of the second driving transistor T8. During a period t5, the light-emitting control signal PAM-EM provides an enable signal to control the first control transistor T5 and the second control transistor T6 to be turned on, and the first driving transistor T1 generates the driving current under the control of its gate voltage; and the light-emitting control signal PWM-EM provides an enable signal to control the third control transistor T12 and the fourth control transistor T13 to be turned on. Due to the coupling effect of the second capacitor C2, as the voltage of the sweep signal sweep changes, the gate potential of the second driving transistor T8 changes. When the gate potential of the second driving transistor T8 reaches a certain level, it controls the second driving transistor T8 to be turned on. After the second driving transistor T8 is turned on, the potential of the first node N1 is caused to change. When the potential of the first node N1 reaches a certain value, it controls the first driving transistor T1 to be turned off, stopping the supply of the driving current to the light-emitting device PD. The period t5 is a light-emitting stage during which the pixel circuit 30 operates. As shown in FIG. 3, the falling edge of the light-emitting control signal PAM-EM is earlier than the falling edge of the light-emitting control signal PWM-EM, and the falling edge of the light-emitting control signal PAM-EM may be regarded as the start moment of the light-emitting stage. The effective level pulse width of the light-emitting control signal PAM-EM affects the duration of the light-emitting stage, and thus also affects the actual adjustable light-emitting time of the light-emitting device PD.

In the embodiment of the present disclosure, it is necessary to distinguish between the light-emitting stage of the pixel circuit 30 and the actual light-emitting time of the light-emitting device PD. The light-emitting device PD emits light in the light-emitting stage, and the actual light-emitting duration of the light-emitting device PD in the light-emitting stage varies according to the different grayscales displayed by the light-emitting device PD. The start moment of the light-emitting stage is the start moment when the light-emitting device PD actually emits light, and the duration of the light-emitting stage determines the maximum time for which the light-emitting device PD actually emits light.

In some embodiments of the present disclosure, the output terminal of the shift register unit 10 is electrically connected to the gate (i.e., the control terminal) of the first control transistor T5 and the gate (i.e., the control terminal) of the second control transistor T6 in the first driving circuit 31; that is, the shift register unit 10 provides the light-emitting control signal PAM-EM to the pixel circuit 30. In some other implementations, the output terminal of the shift register unit 10 is electrically connected to the second electrode plate of the second capacitor C2 in the second driving circuit 32; that is, the shift register unit 10 provides the sweep signal sweep to the pixel circuit 30.

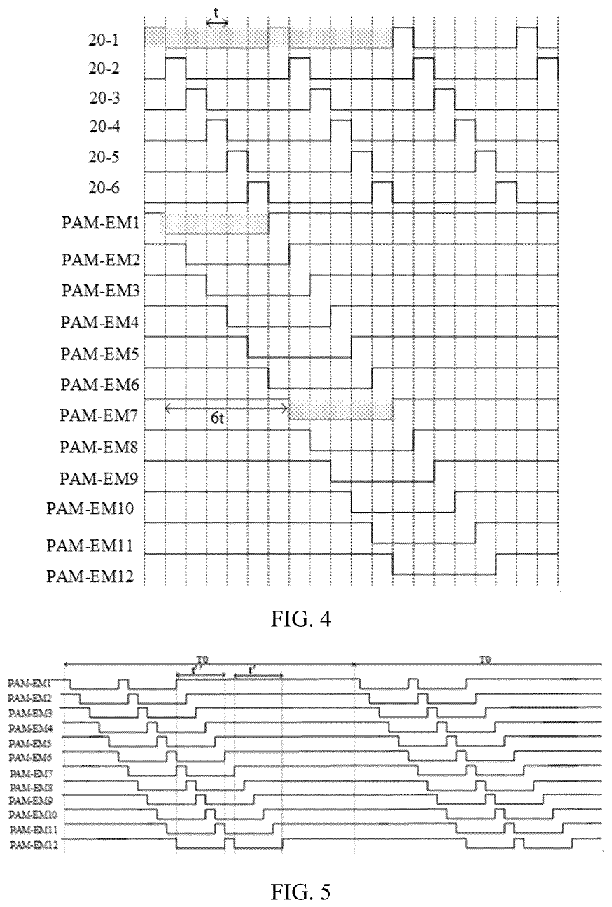

Take the following as an example: the output terminal of the shift register unit 10 is electrically connected to the gate of the first control transistor T5 and the gate of the second control transistor T6 in the first driving circuit 31. FIG. 4 is another signal timing diagram according to an embodiment of the present disclosure. FIG. 4 illustrates signal waveforms of the first gating signal line 20-1, the second gating signal line 20-2,. to the sixth gating signal line 20-6, and waveforms of light-emitting control signals PAM-EM1, PAM-EM2 to PAM-EM12 sequentially output by 12 shift register units 10 that are cascaded when n=6. It can be seen from FIG. 4 that the first gating signal line 20-1 controls the output of the light-emitting control signals PAM-EM1 and PAM-EM12. In FIG. 4, t is marked as row time, the row time refers to the total time required to complete scanning of one pixel circuit row, the row time is related to a refresh rate of the panel, and the shorter the row time, the higher the refresh rate. If the display panel includes N pixel circuit rows 30H, then N*t is the time required for the display panel to scan once from top to bottom, that is, the time required for the display panel to refresh one frame, i.e., one frame time. When the display panel is driven by using the signal timing shown in FIG. 4, the pixel circuits 30 in the pixel circuit row 30H include one light-emitting stage within one frame time. FIG. 4 illustrates that the signals provided by the gating signal lines have a cycle of 6t, and the plurality of shift register units 10 that are cascaded are alternately connected to the 6 gating signal lines in sequence, and thus the effective level pulse width (i.e., the width of the effective pulse) of the light-emitting control signal PAM-EM output by the shift register units 10 is limited by the signal cycle on the gating signal line 20.

In order to increase the light-emitting time of the light-emitting device PD, it is desirable to set a plurality of light-emitting stages for the pixel circuits 30 in the pixel circuit row 30H. However, if the light-emitting devices PD driven by each pixel circuit row 30H are caused to emit light intensively within one frame simply by increasing the number of trigger times of the start signal in the shift register unit, the problem of display flicker is likely to occur.

In addition, if the pixel circuits 30 in one pixel circuit row 30H include two or more light-emitting stages within one frame time, and the light-emitting stages are relatively concentrated, it is also prone to cause load differences on the gating signal lines 20, resulting in different signal delays and thus affecting display uniformity. FIG. 5 is a signal timing diagram in the related art. Take the following as an example: a display panel includes 6 gating signal lines, and the shift register units outputting the light-emitting control signals PAM-EM are connected to the gating signal lines 20. It is assumed that there are 12 pixel circuit rows in total, corresponding to the light-emitting control signals PAM-EM1 to PAM-EM12, respectively. It can be understood that the shift register unit for generating the light-emitting control signal PAM-EM1 and the shift register unit for generating the light-emitting control signal PAM-EM7 are connected to the same gating signal line 20; the shift register unit for generating the light-emitting control signal PAM-EM2 and the shift register unit for generating the light-emitting control signal PAM-EM8 are connected to the same gating signal line 20; and so on. The low-level period of the light-emitting control signal PAM-EM corresponds to the light-emitting stage during which the pixel circuit operates.

It can be seen from FIG. 5 that within the first time T0, the light-emitting control signal PAM-EM has two low-level periods, and the low-level periods are relatively concentrated. For the gating signal line 20 to which the shift register unit for generating the light-emitting control signal PAM-EM6 and the shift register unit for generating the light-emitting control signal PAM-EM12 are connected, during the time period t″, this gating signal line 20 controls and generates the second low-level signal of the light-emitting control signal PAM-EM6 and the first low-level period of the light-emitting control signal PAM-EM12; while during the time period t′, this gating signal line 20 only controls and generates the second low-level period of the light-emitting control signal PAM-EM12. That is, the number of pixel circuit rows 30H driven by this gating signal line 20 during the time period t″ and the time period t′ is different. Although one gating signal line 20 is connected to a plurality of shift register units, the one gating signal line 20 cannot control the plurality of shift register units connected thereto to simultaneously output effective levels, that is, the one gating signal line 20 generally cannot drive a plurality of pixel circuit rows 30H to simultaneously be in the light-emitting stage. When the pixel circuit row 30H has two or more light-emitting stages within the first time T0, the gating signal line 20 drives different numbers of pixel circuit rows 30H to be in the light-emitting stage in different time periods, which will cause load differences between different gating signal lines 20, thereby making the signal delays of the gating signal lines 20 different, and also making the delays of the light-emitting control signals PAM-EM generated thereby have differences. Moreover, the light-emitting control signals PAM-EM control the start moment of the light-emitting stage (which is also the time when the light-emitting device PD starts to emit light), which will cause the light-emitting time of the light-emitting device PD to be affected by different delays, thereby affecting display uniformity.

Based on this, in the embodiment of the present disclosure, the operating mode of the display panel is set, such that within a time equal to the duration of one frame time, the pixel circuit row is set to include at least two light-emitting stages, and the time interval t*m between two adjacent light-emitting stages is a fixed value, so that the light-emitting device can emit light relatively uniformly, avoiding the problem of display flicker. Then, in a further embodiment, the relationship between m and the total number N of pixel circuit rows is set, such that when each gating signal line drives the pixel circuit rows to be in the light-emitting stage, the number of pixel circuit rows simultaneously driven by each gating signal line is equal. Thereby, the delay difference on the gating signal lines is improved, and the display uniformity is enhanced. The above is the main technical idea of the present disclosure, and the technical concept of the present disclosure will be explained below in specific embodiments.

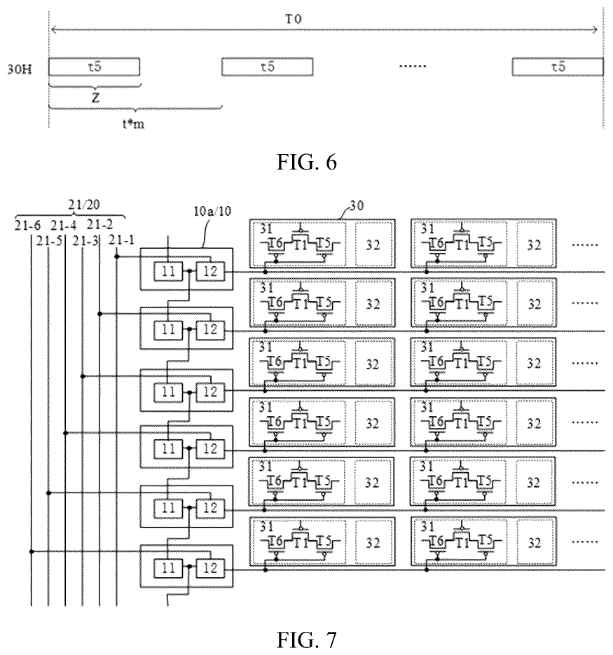

FIG. 6 is a schematic diagram of an operating mode of a display panel according to an embodiment of the present disclosure. FIG. 6 illustrates the light-emitting stages of the pixel circuit row 30H within the first time. As shown in FIG. 6, in the embodiment of the present disclosure, the operating mode of the display panel includes:

The pixel circuit row 30H includes at least two light-emitting stages t5 (the time t5 as illustrated in FIG. 3) within the first time T0, where the duration of the first time T0 is equal to the duration of one frame time, and the time interval between two adjacent light-emitting stages t5 is t*m. Where t is the row time, m is a coefficient; and t=T/N, where T is one frame time, m is a positive integer, and m>n. The time interval between two adjacent light-emitting stages t5 is calculated based on the time interval between the start moments of the two light-emitting stages t5. When the display panel is displaying, a plurality of pixel circuits 30 in one pixel circuit row 30H are driven simultaneously, and thus the pixel circuit row 30H including the light-emitting stage t5 means that the pixel circuits 30 in the pixel circuit row 30H include the light-emitting stage t5.

In the embodiment of the present disclosure, the number n of gating signal lines 20 affects the duration of the light-emitting stage t5. This can be understood in conjunction with the timing illustrated in FIG. 4: the number n of gating signal lines 20 affects the effective level width of the light-emitting control signal PAM-EM, which in turn affects the duration of the light-emitting stage t5. In the embodiment of the present disclosure, the pixel circuit row 30H is set to include at least two light-emitting stages t5 within a time (i.e., the first time T0) equal to one frame time, and the time interval between two adjacent light-emitting stages t5 is t*m, where m is greater than the number n of gating signal lines 20; thus, the time interval between two adjacent light-emitting stages t5 is greater than t*n. Such a setting can ensure that in the case where the number n of gating signal lines 20 is determined, the duration of the light-emitting stage t5 is sufficiently long, and the time interval between two adjacent light-emitting stages t5 of the pixel circuit row 30H within the first time T0 is a fixed value. In this way, the light-emitting device PD driven by the pixel circuit row 30H can emit light at least twice within the first time T0, and the time interval between the start moments of two adjacent light emissions is equal, enabling the light-emitting device PD to emit light relatively uniformly within the first time T0 and avoiding the problem of display flicker caused by concentrated light emission within one frame time.

In some implementations, FIG. 7 is a schematic diagram of another display panel according to an embodiment of the present disclosure. As shown in FIG. 7, the shift register unit 10 includes a first shift register unit 10a, and the first shift register unit 10a includes a driving module 11 and a gating module 12. The gating signal line 20 includes a first gating signal line 21, and the first gating signal line 21 is connected to the first shift register unit 10a. Taking n=6 as an example, the display panel includes 6 first gating signal lines 21, which are the first gating signal lines 21-1, 21-2, 21-3, 21-4, 21-5, and 21-6, respectively. The 6 first gating signal lines 21 are sequentially connected to a plurality of first shift register units 10a that are cascaded. The pixel circuit 30 in FIG. 7 is only a simplified illustration, and the complete structure of the pixel circuit 30 can be understood with reference to the aforementioned FIG. 2. The pixel circuit 30 includes a first driving circuit 31, and the first driving circuit 31 includes a first driving transistor T1, a first control transistor T5, and a second control transistor T6. The first driving transistor T1 is connected in series between the first control transistor T5 and the second control transistor T6. An output terminal of the gating module 12 in the first shift register unit 10a is connected to a control terminal of the first control transistor T5 and a control terminal of the second control transistor T6. In this implementation, the first shift register unit 10a provides a light-emitting control signal PAM-EM to the first driving circuit 31 in the pixel circuit 30.

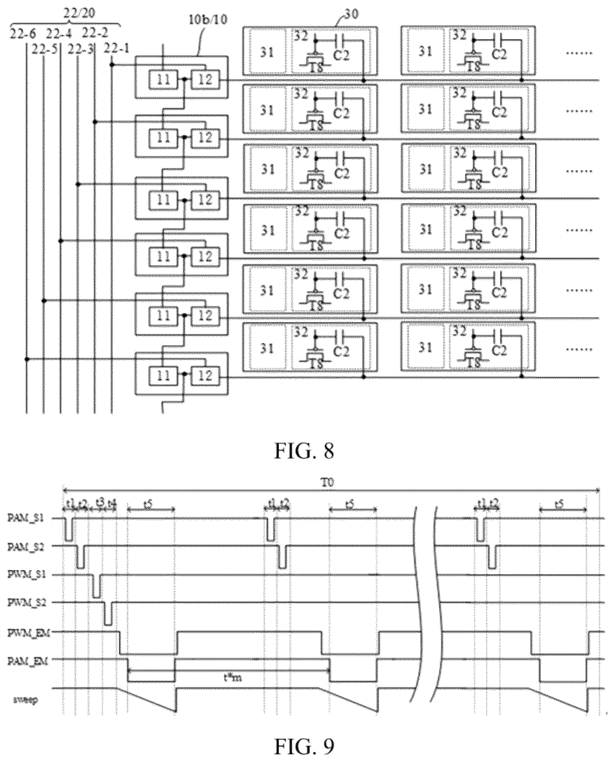

In some other implementations, FIG. 8 is a schematic diagram of another display panel according to an embodiment of the present disclosure. As shown in FIG. 8, the shift register unit 10 includes a second shift register unit 10b, the gating signal line 20 includes a second gating signal line 22, and the second gating signal line 22 is connected to the second shift register unit 10b. Taking n=6 as an example, the display panel includes 6 second gating signal lines 22, which are the second gating signal lines 22-1, 22-2, 22-3, 22-4, 22-5, and 22-6, respectively. The 6 second gating signal lines 22 are sequentially connected to a plurality of second shift register units 10a that are cascaded. The pixel circuit 30 in FIG. 8 is only a simplified illustration, and the complete structure of the pixel circuit 30 may be understood with reference to FIG. 2. The pixel circuit 30 includes a second driving circuit 32, the second driving circuit 32 includes a second driving transistor T8 and a second capacitor C2. An output terminal of the gating module 12 in the second shift register unit 10b is connected to the second driving circuit 32. Specifically, the output terminal of the gating module 12 in the second shift register unit 10b is connected to the second capacitor C2, that is, a control signal output by the output terminal of the second shift register unit 10b is a sweep signal sweep.

FIG. 9 is another signal timing diagram according to an embodiment of the present disclosure. The signal timing provided in the embodiment of FIG. 9 can drive the pixel circuit 30 provided in the embodiment of FIG. 2. Using the signal timing provided in the embodiment of FIG. 9 can realize that the pixel circuits 30 in the pixel circuit row 30H include at least two light-emitting stages t5 within the first time T0, and the time interval between two adjacent light-emitting stages t5 is t*m. The time interval between two adjacent light-emitting stages t5 is calculated by the time interval between the start moments of the two light-emitting stages t5. Specifically, it is calculated by the time interval between the falling edges of the light-emitting control signal PAM-EM in the two adjacent light-emitting stages t5.

FIG. 9 only uses the signal timing within the first time T0 being exactly the signal timing within one frame time for illustration. As shown in FIG. 9, in the display of one frame, the pixel circuit 30 goes through the t1 period, t2 period, t3 period and t4 period to complete the writing of the first data voltage PAM-data and the writing of the second data voltage PWM-data, and then executes the first light-emitting stage t5. After the first light-emitting stage t5, the first driving transistor T1 in the first driving circuit 31 is in an off state. In order to realize the next light-emitting stage t5, it is necessary to turn on the first driving transistor T1. Therefore, after the light-emitting stage t5, there is included at least the t2 period, or there may be also included both the t2 period and the t1 period. In the t2 period, the first data voltage PAM-data is written to the gate of the first driving transistor T1. Since the light-emitting devices PD of the same color in the entire display panel use the same first data voltage PAM-data, performing multiple writings of the first data voltage PAM-data during the driving process of one pixel circuit row 30H in one frame display will not have an abnormal impact on the driving of other pixel circuit rows 30H.

The first shift register unit 10a in the embodiment of FIG. 7 may provide the light-emitting control signal PAM-EM as shown in the timing diagram of FIG. 9 to the first driving circuit 31 in the pixel circuit 30, and the second shift register unit 10b in the embodiment of FIG. 8 may provide the sweep signal sweep as shown in the timing diagram of FIG. 9 to the second driving circuit 32 in the pixel circuit 30. The first shift register unit 10a and the second shift register unit 10b cooperate to realize that the pixel circuit 30 in the pixel circuit row 30H includes at least two light-emitting stages t5 in the first time T0, and the time interval between two adjacent light-emitting stages t5 is t*m.

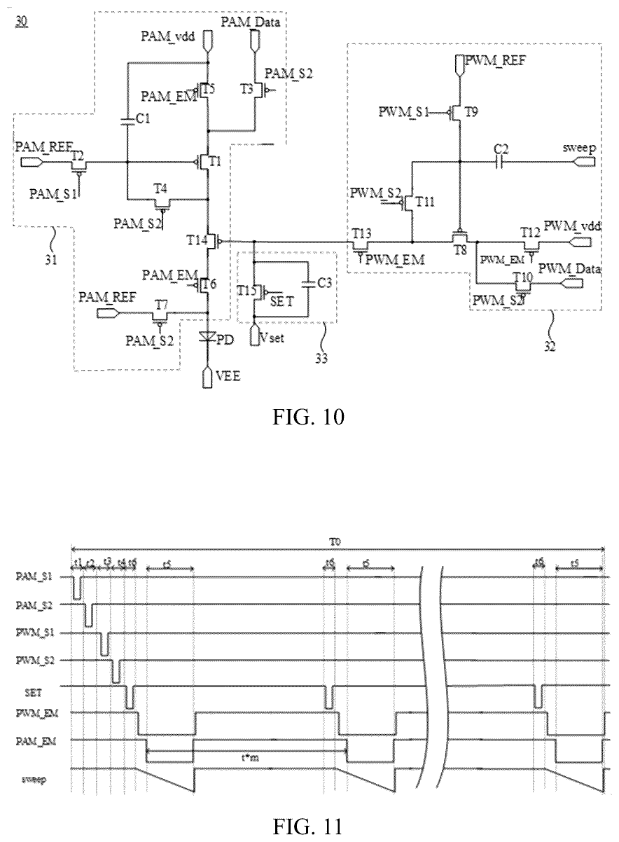

In some other implementations, FIG. 10 is a schematic diagram of another pixel circuit according to an embodiment of the present disclosure. As shown in FIG. 10, the pixel circuit 30 includes a first driving circuit 31 and a second driving circuit 32. The first driving circuit 31 includes a first driving transistor T1, a first gate reset transistor T2, a first data writing transistor T3, a first compensation transistor T4, a first control transistor T5, a second control transistor T6, an electrode reset transistor T7, a first capacitor C1, and a light-emitting duration control transistor T14. The light-emitting duration control transistor T14 is connected in series between the first driving transistor T1 and a light-emitting device PD. The second driving circuit 32 includes a second driving transistor T8, a second gate reset transistor T9, a second data writing transistor T10, a second compensation transistor T11, a third control transistor T12, a fourth control transistor T13 and a second capacitor C2. In the second driving circuit 32, the fourth control transistor T13 is electrically connected to a gate of the light-emitting duration control transistor T14. The pixel circuit 30 further includes a reset circuit 33, the reset circuit 33 is electrically connected to the gate of the light-emitting duration control transistor T14 and is configured to reset a gate potential of the light-emitting duration control transistor T14. Optionally, the reset circuit 33 includes a reset transistor T15 and a third capacitor C3. A gate of the reset transistor T15 receives a reset control signal SET, a first electrode of the reset transistor T15 receives a reset signal Vset, and a second electrode of the reset transistor T15 is connected to the gate of the light-emitting duration control transistor T14. A first electrode plate of the third capacitor C3 receives the reset signal Vset, and a second electrode plate of the third capacitor C3 is connected to the gate of the light-emitting duration control transistor T14. The reset signal Vset is a constant voltage signal, such as a low-level constant voltage signal, and the reset signal Vset can control the light-emitting duration control transistor T14 to be turned on.

In some implementations, the pixel circuits 30 in the embodiments of FIG. 7 and FIG. 8 may also be the structure shown in FIG. 10.

FIG. 11 is another signal timing diagram according to an embodiment of the present disclosure, and the pixel circuit provided in FIG. 10 may be driven by using the signal timing provided in FIG. 11. As shown in FIG. 11, the operation of the pixel circuit 30 not only includes the period t1, the period t2, the period t3, the period t4, and the period t5, but also includes a period t6. For the operating conditions of the pixel circuit in the period t1, the period t2, the period t3 and the period t4, reference may be made to the above description in the embodiment of FIG. 3, and details are not described herein again. The period t6 is a reset stage; and during the period t6, the reset control signal SET provides an enable level to control the reset transistor T15 to be turned on, so as to write the reset signal Vset into the gate of the light-emitting duration control transistor T14, thus making the light-emitting duration control transistor T14 turned on. During the period t5, the light-emitting control signal PAM-EM provides an enable signal to control the first control transistor T5 and the second control transistor T6 to be turned on, the first driving transistor T1 generates a driving current under the control of its gate voltage, and since the light-emitting duration control transistor T14 is in an on state, the driving current is supplied to the light-emitting device PD to make it emit light; the light-emitting control signal PWM-EM provides an enable signal to control the third control transistor T12 and the fourth control transistor T13 to be turned on, with the voltage change of the sweep signal sweep, the gate potential of the second driving transistor T8 changes due to the coupling effect of the second capacitor C2, when the gate potential of the second driving transistor T8 reaches a certain level, the second driving transistor T8 is controlled to be turned on, after the second driving transistor T8 is turned on, the potential of the gate of the light-emitting duration control transistor T14 is caused to change, and when the potential of the gate of the light-emitting duration control transistor T14 reaches a certain value, the light-emitting duration control transistor T14 is controlled to be turned off, so as to stop the supply of the driving current to the light-emitting device PD. The period t5 is the light-emitting stage during which the pixel circuit 30 operates.

By using the signal timing provided in the embodiment of FIG. 11, it is possible to realize that the pixel circuit 30 in the pixel circuit row 30H includes at least two light-emitting stages t5 in the first time T0, and the time interval between two adjacent light-emitting stages t5 is t*m. FIG. 10 only uses the signal timing within the first time T0 being exactly the signal timing within one frame time for illustration. In the display of one frame, the pixel circuit 30 goes through the period t1, the period t2, the period t3 and the period t4 to complete the writing of the first data voltage PAM-data and the writing of the second data voltage PWM-data, and then executes the period t6 and the first light-emitting stage t5. After the first light-emitting stage t5, the light-emitting duration control transistor T14 is in an off state; in order to realize the next light-emitting stage t5, it is necessary to turn on the light-emitting duration control transistor T14. Therefore, the period t6 is further included between two adjacent light-emitting stages t5, and in the period t6, the gate potential of the light-emitting duration control transistor T14 is reset to turn on the light-emitting duration control transistor T14. Thereby, it is possible to realize that the pixel circuit 30 in the pixel circuit row 30H performs two or more light-emitting stages t5 after writing the first data voltage PAM-data once and the second data voltage PWM-data once.

In some implementations of the present disclosure, N is an integer multiple of m. That is, the number N of the pixel circuit rows 30H in the display panel has an integer multiple relationship with m. In the first time T0, the number of the light-emitting stages t5 included in one pixel circuit row 30H is T/(t*m); since t=T/N, T/(t*m)=N/m, and T/(t*m) is an integer. That is, the number of the light-emitting stages t5 included in one pixel circuit row 30H in the first time T0 is an integer, and the number of the light-emitting stages t5 included in each pixel circuit row 30H in the respective first time T0 is equal. Where the pixel circuit row 30H includes w light-emitting stages in the first time, w=N/m, and w is an integer.

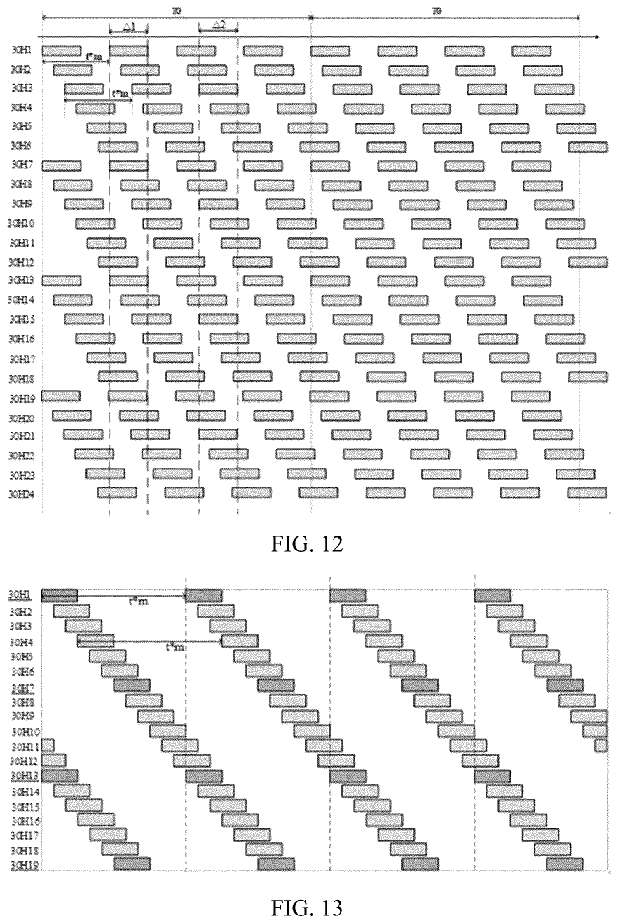

FIG. 12 is a schematic diagram of another operating mode of a display panel according to an embodiment of the present disclosure. FIG. 12 takes n=6 and w=N/m=4 as an example, that is, 6 gating signal lines 20 are arranged in the display panel, each pixel circuit row 30H has 4 light-emitting stages t5 in the first time T0, and the time interval between two adjacent light-emitting stages t5 is t*m. The light-emitting stage t5 is illustrated in FIG. 12 with gray filling. FIG. 12 illustrates light-emitting stages t5 respectively corresponding to pixel circuit rows 30H1 to 30H24 arranged consecutively. The display panel includes the first shift register unit 10a illustrated in FIG. 7, the first shift register unit 10a provides the light-emitting control signal PAM-EM to the pixel circuit row 30H, and the first shift register units 10a connected to the pixel circuit row 30H1, the pixel circuit row 30H7, the pixel circuit row 30H13, and the pixel circuit row 30H19 are connected to the same first gating signal line 21. It can be seen that the light-emitting stages t5 of the pixel circuit row 30H1, the pixel circuit row 30H7, the pixel circuit row 30H13, and the pixel circuit row 30H19 occur simultaneously, that is, the pixel circuit rows 30H are driven with a cycle of 6 rows.

FIG. 12 illustrates two consecutive first times T0, the start moment of the first time T0 is the start light-emitting moment of one light-emitting stage t5 of the pixel circuit row 30H1. It can be seen from FIG. 12 that the pixel circuit row 30H includes 4 light-emitting stages, and the time intervals between any two adjacent light-emitting stages are equal and all equal to t*m. The duration of the first time T0 is equal to the duration of one frame time, and it can be understood that the first time T0 marked in FIG. 12 is not the period in which one frame of image is actually displayed, and any pixel circuit row 30H in the display panel includes 4 light-emitting stages in its corresponding first time T0, and the time intervals between any two adjacent light-emitting stages are equal.

FIG. 12 illustrates 24 pixel circuit rows 30H. One gating signal line 20 correspondingly drives 4 of the 24 pixel circuit rows 30H through the shift register units, and 6 gating signal lines 20 alternately drive the 24 pixel circuit rows arranged in sequence. A period Δ1 corresponds to one light-emitting stage of the pixel circuit row 30H1, and it can be seen that the gating signal line 20 driving the pixel circuit row 30H1 in the period Δ1 simultaneously drives 4 pixel circuit rows to be in the light-emitting stage. A period Δ2 corresponds to one light-emitting stage of the pixel circuit row 30H3, and it can be seen that the gating signal line 20 driving the pixel circuit row 30H3 in the period Δ2 simultaneously drives 4 pixel circuit rows to be in the light-emitting stage. In this way, it can ensure that when each gating signal line 20 drives the pixel circuit rows 30H to be in the light-emitting stage, the number of the pixel circuit rows 30H simultaneously driven by each gating signal line 20 to be in the light-emitting stages is equal.

In the embodiment of the present disclosure, it is set that the pixel circuit row 30H includes at least two light-emitting stages t5 in the first time T0, the time interval between two adjacent light-emitting stages t5 is t*m, and m>n, and N is an integer multiple of m. The time interval between two adjacent light-emitting stages t5 in the first time T0 of the pixel circuit row 30H is a fixed value, so that the light-emitting device PD driven by the pixel circuit row 30H can emit light at least twice relatively uniformly in the first time T0, avoiding the problem of display flicker caused by concentrated light emission within one frame time. Moreover, it can be realized that the number of pixel circuit rows 30H that are driven by each gating signal line 20 to simultaneously be in the light-emitting stage is equal, thereby being capable of reducing the load differences of each gating signal line 20 in different periods, reducing the delay differences of the output signals of the shift register units, and improving display uniformity.

In some other implementations, the number of pixel circuit rows 30H actually included in the display panel is not an integer multiple of m. However, N+r is an integer multiple of m, where r is an integer. The pixel circuit row 30H includes w light-emitting stages t5 in the first time, and w=(N+r)/m. Under the condition that it is set that the pixel circuit row 30H includes at least two light-emitting stages t5 in the first time T0, the time interval between two adjacent light-emitting stages t5 is t*m, m>n, and N+r is an integer multiple of m, it can also be realized that the light-emitting device PD driven by the pixel circuit row 30H can emit light at least twice relatively uniformly in the first time T0, the number of light-emitting stages included in each pixel circuit row 30H in the first time T0 is equal, and the problem of display flicker caused by concentrated light emission within one frame time is avoided.

Optionally, 1≤r<m. Since N+r is an integer multiple of m and 1≤r<m, when N is an integer multiple of n, the number of pixel circuit rows 30H driven by different gating signal lines 20 through the gating modules 12 to simultaneously be in the light-emitting stage t5 is equal. When N is not divisible by n, the gating signal lines 20 will be divided into two categories, and the number of pixel circuit rows 30H simultaneously driven by the two categories of gating signal lines 20 to be in the light-emitting stage may differ by 1; however, overall, compared with before the improvement, it is still possible to reduce the load differences of each gating signal line 20 in different time periods, reduce the delay differences of the output signals of the shift register units, and improve display uniformity.

In some implementations, the output terminal of the gating module 12 in the shift register unit 10 is connected to k pixel circuit rows 30H, where k is an integer and k≥1; the duration of the light-emitting stage t5 is Z, and Z≤k*t*n. For example, when k=1, Z≤t*n; when k=2, Z≤2*t*n. When k=1, one shift register unit 10 drives one pixel circuit row 30H; when k=2, one shift register unit 10 drives two pixel circuit rows 30H. The greater the number of pixel circuit rows 30H connected to the output terminal of the shift register unit 10, the longer the duration of the single light-emitting stage of the pixel circuit, and the more the number of gating signal lines 20 provided in the display panel, the longer the duration of the single light-emitting stage of the pixel circuit. In the embodiment of the present disclosure, the duration of the single light-emitting stage of the pixel circuit is set to be related to k and n, so that the duration of the single light-emitting stage is sufficiently long to meet the requirement of the light-emitting device PD for the light-emitting duration in grayscale display.

In some implementations, the respective light-emitting stages t5 of the pixel circuit row 30H in the first time T0 have equal durations. Thus, the light-emitting control signals that drive the pixel circuit row 30H to operate can be set regularly; and by setting the effective level width of the light-emitting control signals to a fixed value to make the durations of the respective light-emitting stages t5 equal, the manner in which the control signals are generated will be relatively simple. As understood in conjunction with the timing diagram illustrated in FIG. 3, the falling edge of the light-emitting control signal PWM-EM is earlier than the falling edge of the light-emitting control signal PAM-EM, and the rising edge of the light-emitting control signal PWM-EM is later than the rising edge of the light-emitting control signal PAM-EM, that is, the low level of the light-emitting control signal PWM-EM covers the low level of the light-emitting control signal PAM-EM; then the light-emitting control signal PAM-EM required by the pixel circuit 30 affects the duration of the light-emitting stage t5. In applications, at least the respective low-level pulse widths of the light-emitting control signal PAM-EM are set to be equal, so that the durations of the respective light-emitting stages t5 of the pixel circuit row 30H are equal.

In some implementations, the output terminal of the gating module 12 in the shift register unit 10 is connected to k pixel circuit rows 30H, k is an integer, and k≥1; m is an integer multiple of k*n. Such a setting can reduce the load differences of each gating signal line 20 in different time periods, reduce the delay differences of the output signals of the shift register units, and improve the display uniformity.

FIG. 1 takes k=1 as an example, that is, one shift register unit 10 drives one pixel circuit row 30H; then m is an integer multiple of n, and since m>n, m is at least 2 times of n, and the duration of the light-emitting stage is Z≤t*n. When k=2, m is an integer multiple of 2*n, and the duration of the light-emitting stage is Z≤k*t*n=2*t*n; in this case, it is also required to satisfy that the time interval between two adjacent light-emitting stages is greater than the duration of a single light-emitting stage, that is, it is required to simultaneously satisfy t*m>Z, then t*m>2*t*n, and m is at least 2 times of 2*n.

Taking k=1 as an example, m is at least 2 times of n. n is the number of gating signal lines 20 arranged in the display panel, and the n gating signal lines 20 are alternately connected to the plurality of shift register units 10 that are cascaded, that is, the plurality of shift register units 10 that are cascaded are connected to the corresponding gating signal lines 20 in a cycle of n. As understood in conjunction with the embodiment in FIG. 4, the periodic signals on the gating signal lines 20 control the shift register units 10 to output the light-emitting control signals PAM-EM, thereby controlling the pixel circuit rows 30H to operate in the light-emitting stage t5. When the time interval between two adjacent light-emitting stages t5 of the pixel circuit rows 30H in the first time T0 is t*m, and m is an integer multiple of n, it is possible to realize that one gating signal line 20 drives multiple pixel circuit rows 30H to simultaneously operate in the light-emitting stage. Where the specific number of pixel circuit rows 30H that one gating signal line 20 drives to simultaneously operate in the light-emitting stage is related to the specific value of m.

When N/n is an integer, one gating signal line 20 is connected to N/n shift register units 10, and one gating signal line 20 can drive at most N/n pixel circuit rows 30H. It can be understood that one gating signal line 20 drives multiple pixel circuit rows 30H to simultaneously operate in the light-emitting stage, and the number of pixel circuit rows 30H that simultaneously operate in the light-emitting stage is less than N/n. Moreover, since m is an integer multiple of k*n, the larger the value of m, the smaller the number of pixel circuit rows 30H that one gating signal line 20 drives to simultaneously operate in the light-emitting stage.

Taking k=1, where one shift register unit 10 is connected to one pixel circuit row 30H, as an example, FIG. 13 is a schematic diagram of another operating mode of a display panel according to the embodiment of the present disclosure. FIG. 13 illustrates the schematic diagram of the light-emitting stages t5 of the pixel circuit rows 30H1 to 30H19 arranged in sequence within a certain period of time. In the figure, the time positions of the light-emitting stages t5 are illustrated with gray filling. FIG. 13 still takes n=6 as an example, and thus the shift register units 10 respectively connected to the pixel circuit row 30H1, the pixel circuit row 30H7, the pixel circuit row 30H13, and the pixel circuit row 30H19 are connected to the same gating signal line 20. In FIG. 13, the light-emitting stages t5 driven by the same gating signal line 20 are illustrated with darker filling. It can be seen from FIG. 13 that the light-emitting stages t5 of the pixel circuit row 30H1 and the light-emitting stages t5 of the pixel circuit row 30H13 are driven simultaneously, and the light-emitting stages t5 of the pixel circuit row 30H7 and the light-emitting stages t5 of the pixel circuit row 30H19 are driven simultaneously. That is, the number of pixel circuit rows 30H driven by the gating signal line 20 to simultaneously operate in the light-emitting stages t5 is less than the number of pixel circuit rows 30H electrically connected to the gating signal line 20 through the shift register units 10. Moreover, the larger the value of m, the smaller the number of pixel circuit rows 30H driven by one gating signal line 20 to simultaneously operate in the light-emitting stages.

In addition, when N/n is an integer and m is an integer multiple of k*n, the relationship between N and m may be that N is an integer multiple of m, or that N+r is an integer multiple of m.

When N is an integer multiple of m, at the start moment of the light-emitting stage t5 of the pixel circuit rows 30H, the number of the pixel circuit rows 30H driven by the n gating signal lines 20 through the gating modules 12 to be in the light-emitting stage t5 is equal. In the embodiment of the present disclosure, it is possible to reduce the load differences of each gating signal line 20 in different time periods, reduce the delay differences of the output signals of the shift register units, and improve the display uniformity. Where the duration of the first time T0 is equal to the duration of one frame time T, and within the first time T0, the N pixel circuit rows 30H are driven row by row; thus the number of the light-emitting stages t5 included in the pixel circuit rows 30H in the first time T0 is equal to the number of the pixel circuit rows 30H simultaneously driven by one gating signal line 20 to be in the light-emitting stages t5 in one frame time T. Therefore, when N is an integer multiple of m, the number of the pixel circuit rows 30H driven by the n gating signal lines 20 through the gating modules to simultaneously be in the light-emitting stages t5 is N/m.

When N+r is an integer multiple of m, the number of pixel circuit rows 30H driven by different gating signal lines 20 through the gating modules 12 to simultaneously be in the light-emitting stage t5 differs by at most 1. Optionally, 1≤r<m. In the embodiment of the present disclosure, it is possible to reduce the load differences of each gating signal line 20 in different time periods, reduce the delay differences of the output signals of the shift register units, and improve the display uniformity.

When N is an integer multiple of m, the number of light-emitting stages t5 included in the pixel circuit rows 30H in the first time T0 is equal to the number of pixel circuit rows 30H simultaneously driven by one gating signal line 20 to be in the light-emitting stage t5 in one frame time T. Then, when N+r is an integer multiple of m, this is equivalent to arranging r virtual pixel circuit rows in the display panel; this enables the total number of pixel circuit rows to be divisible by m, so the number of light-emitting stages t5 included in the pixel circuit rows 30H in the first time T0 is (N+r)/m. Due to the arrangement of the r virtual pixel circuit rows, when N is an integer multiple of n, the number of pixel circuit rows 30H driven by different gating signal lines 20 through the gating modules 12 to simultaneously be in the light-emitting stage t5 is equal. When N is not divisible by n, at least one of the n gating signal lines 20 is preset to drive virtual pixel circuit rows; that is, the number of pixel circuit rows actually driven by at least one of the n gating signal lines 20 will be smaller. When 1≤r<m, among the n gating signal lines 20, the number of pixel circuit rows 30H driven by some of the gating signal lines 20 through the gating modules 12 to simultaneously be in the light-emitting stage t5 is (N+r)/m, and the number of pixel circuit rows 30H driven by the remaining gating signal lines 20 through the gating modules 12 to simultaneously be in the light-emitting stage t5 is N/m, where (N+r)/m =N/m+1.

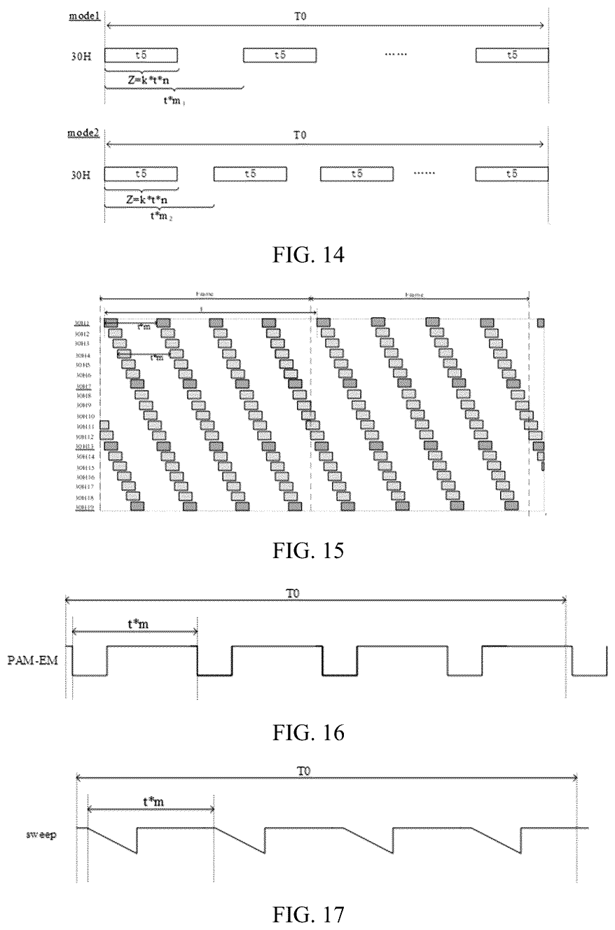

In some implementations, FIG. 14 is a schematic diagram of another operating mode of a display panel according to an embodiment of the present disclosure. As shown in FIG. 14, the operating mode of the display panel includes a first mode mode1 and a second mode mode2, and a brightness of the display panel in the first mode mode1 is less than a brightness of the display panel in the second mode mode2. For example, the first mode mode1 may be a display mode applied in an indoor scenario, and the second mode mode2 may be a display mode applied in an outdoor scenario.

Where the coefficient m includes a first coefficient m₁ and a second coefficient m₂.

In the first mode mode1, the pixel circuit rows 30H include at least two light-emitting stages t5 in the first time T0, and the time interval between two adjacent light-emitting stages t5 is t*m₁.

In the second mode mode2, the pixel circuit rows 30H include at least two light-emitting stages t5 in the first time T0, and the time interval between two adjacent light-emitting stages t5 is t*m₂; where m₁>m₂.

As explained in the relevant embodiments above, the pixel circuit rows 30H include w light-emitting stages t5 in the first time T0, where w=N/m; or, w=(N+r)/m. That is, the larger the coefficient m, the smaller w is. Therefore, it can be understood that in the two modes shown in FIG. 14, the number of the light-emitting stages t5 included in the pixel circuit rows 30H in the first time T0 is different, and the duration of a single light-emitting stage t5 is Z=k*t*n. The number of the light-emitting stages t5 included in the pixel circuit rows 30H in the first time T0 in the first mode mode1 is less than the number of the light-emitting stages t5 included in the pixel circuit rows 30H in the first time T0 in the second mode mode2.

In the embodiment of the present disclosure, differential setting of the coefficient m when the display panel operates in different brightness modes can meet the brightness requirements of the display panel in different application scenarios. In a brightness mode with relatively high brightness, the coefficient m is relatively smaller, and thus the number of light-emitting stages t5 included in the pixel circuit rows 30H in the first time T0 is larger, which makes the total duration of the light-emitting stages of the pixel circuit rows 30H in the first time T0 longer. Thus, the actual light-emitting duration of the light-emitting device PD can be longer and the brightness can be higher, which can meet the brightness requirements of the high-brightness mode.

In some implementations, FIG. 15 is a schematic diagram of another operating mode of a display panel according to an embodiment of the present disclosure. FIG. 15 takes k=1, where one shift register unit 10 is connected to one pixel circuit row 30H, as an example, and illustrates a schematic diagram of the light-emitting stages t5 of the sequentially arranged pixel circuit rows 30H1 to 30H19 when two consecutive frames Frame are displayed. The time positions of the light-emitting stages t5 are illustrated with gray filling in the figure. FIG. 15 still takes n=6 as an example: the shift register units 10 respectively connected to the pixel circuit row 30H1, the pixel circuit row 30H7, the pixel circuit row 30H13, and the pixel circuit row 30H19 are connected to the same gating signal line 20, and the light-emitting stages t5 of the pixel circuit row 30H1, the pixel circuit row 30H7, the pixel circuit row 30H13, and the pixel circuit row 30H19 are illustrated with darker filling. As shown in FIG. 15, the operating mode of the display panel includes: during the display of one frame Frame, N pixel circuit rows 30H are driven sequentially; and the time interval between the start moments of two times of driving the first pixel circuit row 30H1 during the display of two consecutive frames Frame is T. T is the display time of one frame Frame, i.e., one frame time. It can be understood that the time interval between the start moments of two times of driving the second pixel circuit row 30H2 during the display of two consecutive frames Frame is also T. The display panel provided in the embodiment of the present disclosure has no front and back porches when continuously displaying multiple frames, which, combined with the design in the embodiment of the present disclosure where the time interval between two adjacent light-emitting stages t5 of the pixel circuit rows 30H in the first time T0 is t*m, enables that the light-emitting stages t5 during which the pixel circuits 30 in the pixel circuit rows 30H operate are uniformly distributed in time during display, and the light-emitting device PD can also emit light relatively uniformly in time, avoiding the problem of display flicker caused by concentrated light emission.

As can be seen in conjunction with FIG. 1, in the embodiment of the present disclosure, the gating module 12 outputs the control signal to the pixel circuit row 30H connected to the shift register unit 10 at least based on the signal output by the driving module 11 and the signal provided by the gating signal line 20 which are received by the gating module 12. The operating mode of the display panel includes: the control signal includes at least two cycles in the first time T0, and the cycle of the control signal is t*m. Such a setting can utilize the control signal to drive the pixel circuits 30, satisfying that the time interval between two adjacent light-emitting stages t5 in which the pixel circuit row 30H operates is t*m.

Take the following as an example: the shift register unit 10 includes the first shift register unit 10a illustrated in FIG. 7, and the gating signal line 20 includes the first gating signal line 21 illustrated in FIG. 7. FIG. 16 is another signal timing diagram according to an embodiment of the present disclosure. FIG. 16 illustrates the signal timing of the light-emitting control signal PAM-EM required for the operation of the pixel circuit 30. As shown in FIG. 16, the light-emitting control signal PAM-EM includes 4 cycles in the first time T0, one low level and one high level of the light-emitting control signal PAM-EM constitute one signal cycle, and the cycle of the light-emitting control signal PAM-EM is t*m. In FIG. 16, the width between two adjacent falling edges of the light-emitting control signal PAM-EM is defined as the length of one cycle. The light-emitting control signal PAM-EM is a kind of control signal required for the operation of the pixel circuit 30. As can be seen in conjunction with the timing diagram illustrated in FIG. 9 and the structure of the pixel circuit 30 illustrated in FIG. 2, the light-emitting control signal PAM-EM provides a low level to cause the first control transistor T5 and the second control transistor T6 in the first driving circuit 31 to be turned on, and thus the first driving transistor T1 can provide the driving current to the light-emitting device PD. The low level of the light-emitting control signal PAM-EM controls whether the path between the first driving transistor T1 and the light-emitting device PD is conducting, and the duration of the low level of the light-emitting control signal PAM-EM affects the duration of the light-emitting stage t5. The embodiment of the present disclosure sets the cycle of the light-emitting control signal PAM-EM, which can drive the pixel circuit 30 to operate, satisfying that the time interval between two adjacent light-emitting stages t5 in which the pixel circuit row 30H operates is t*m.

Take the following as an example: the shift register unit 10 includes the second shift register unit 10b illustrated in FIG. 8, and the gating signal line 20 includes the second gating signal line 22 illustrated in FIG. 8. FIG. 17 is another signal timing diagram according to an embodiment of the present disclosure. FIG. 17 illustrates the signal timing of the sweep signal sweep required for the operation of the pixel circuit 30. As shown in FIG. 17, the sweep signal sweep includes 4 cycles in the first time T0, one constant voltage signal and one ramp signal of the sweep signal sweep constitute one signal cycle, and the cycle of the sweep signal sweep is t*m. FIG. 17 illustrates that the width between the start moments of two adjacent ramp signals of the sweep signal sweep is defined as the length of one cycle. The sweep signal sweep is a kind of control signal required for the operation of the pixel circuit 30. As can be seen in conjunction with the timing diagram illustrated in FIG. 9 and the structure of the pixel circuit 30 illustrated in FIG. 2, in the light-emitting stage t5, the third control transistor T12 and the fourth control transistor T13 in the second driving circuit 32 are turned on under the control of the light-emitting control signal PWM-EM, the ramp signal of the sweep signal sweep causes the gate potential of the second driving transistor T8 to change, when the gate potential of the second driving transistor T8 reaches a certain level, the second driving transistor T8 is controlled to be turned on, after the second driving transistor T8 is turned on, the potential of the first node N1 is caused to change, and when the potential of the first node N1 reaches a certain value, the first driving transistor T1 is controlled to be turned off, stopping the supply of the driving current to the light-emitting device PD. The sweep signal sweep cooperates with the pixel circuit to operate to complete each light-emitting stage t5. The embodiment of the present disclosure sets the cycle of the sweep signal sweep, which can drive the pixel circuit 30 to operate, satisfying that the time interval between two adjacent light-emitting stages t5 in which the pixel circuit row 30H operates is t*m.

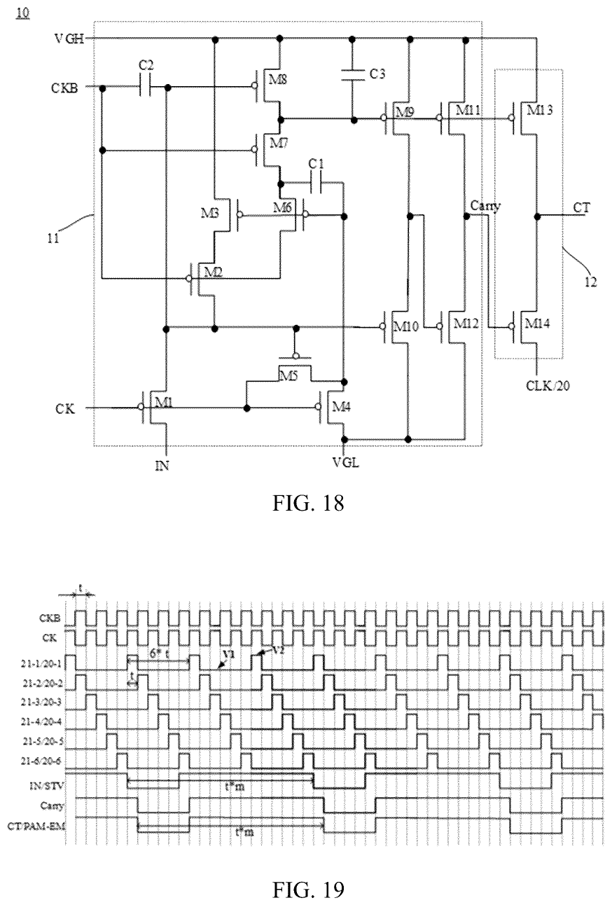

In some implementations, FIG. 18 is a schematic diagram of a shift register unit according to an embodiment of the present disclosure. As shown in FIG. 18, the shift register unit 10 includes the driving module 11 and the gating module 12, the driving module 11 includes a first transistor M1, a second transistor M2, . . . , to a twelfth transistor M12, the driving module 11 further includes a first capacitor C1, a second capacitor C2, and a third capacitor C3, and the gating module 12 includes a thirteenth transistor M13 and a fourteenth transistor M14. The operation of the shift register unit 10 uses a high-level signal VGH, a low-level signal VGL, an input signal IN, a first clock signal CK, a second clock signal CKB, and the gating signal CLK provided by the gating signal line 20, and the gating module 12 is configured to receive at least the signal Carry output by the driving module 11 and the signal CLK provided by the gating signal line 20, and output a control signal CT.

In FIG. 18, the structures of the driving module 11 and the gating module 12 are only schematically represented, and are only used to illustrate the operating principle of the shift register unit 10. In the embodiment of the present disclosure, the first shift register unit 10a and the second shift register unit 10b may adopt the same structure, for example, they may be a structure similar to the structure in the embodiment of FIG. 18.

FIG. 19 is another signal timing diagram according to an embodiment of the present disclosure, and the shift register unit 10 provided in the embodiment of FIG. 18 can be driven by using the signal timing provided in FIG. 19. FIG. 18 takes n=6 as an example, that is, 6 gating signal lines 20 are arranged in the display panel. It can be seen from FIG. 18 that when the pulse cycle of a trigger signal STV received by the driving module 11 in the first stage shift register unit 10 is set to t*m in the operating mode of the display panel, the pulse cycle of the control signal CT output by the shift register unit 10 is t*m. The control signal CT in FIG. 18 can serve as the light-emitting control signal PAM-EM, and using the signal timing provided in the embodiment of FIG. 18 can drive the pixel circuit 30 to operate, such that the time interval between two adjacent light-emitting stages t5 in which the pixel circuit row 30H operates is t*m.

In addition, the gating signal line 20 provides the gating signal, and the cycle of the gating signal is n*t. FIG. 19 takes n=6 as an example, and shows the gating signals output by gating signal lines 20-1 to 20-6 respectively. It can be seen from FIG. 19 that the cycle of the gating signal is 6*t, that is, the cycle of the gating signal is n*t, and the difference between the cycle start moments of the gating signals provided by two adjacent gating signal lines 20 arranged in sequence is t. Such a setting can realize that the plurality of gating modules 12 in the plurality of shift register units 10 are controlled to sequentially output the control signals CT by using the n gating signal lines 20, so as to realize the driving of the plurality of pixel circuit rows 30H row by row.

As can be seen in conjunction with FIG. 7, the shift register unit 10 includes the first shift register unit 10a, the gating signal line 20 includes the first gating signal line 21, and the first gating signal line 21 is connected to the first shift register unit 10a. The signal timing provided in the embodiment of FIG. 19 can drive the first shift register unit 10a provided in the embodiment of FIG. 7. FIG. 19 illustrates the first gating signals provided by 6 first gating signal lines 21 respectively, and the 6 first gating signal lines 21 are the first gating signal line 21-1 to the first gating signal line 21-6 respectively. It can be seen from FIG. 19 that the cycle of the first gating signal provided by the first gating signal line 21 is n*t. The first gating signal includes a first level signal V1 and a second level signal V2, and the first level signal V1 is the enable signal. One of the first level signal V1 and the second level signal V2 is a high-level signal and the other is a low-level signal. The embodiment of the present disclosure takes the following as an example: the first level signal V1 is the low-level signal, and the second level signal V2 is the high-level signal. In one cycle of the first gating signal, the duration of the first level signal V1 is greater than the duration of the second level signal V2. In the embodiment of the present disclosure, setting the cycle of the first gating signal to n*t can realize using the n first gating signal lines 21 to control the plurality of gating modules 12 in the plurality of first shift register units 10a to sequentially output the control signals, so as to realize the driving of the plurality of pixel circuit rows 30H row by row. Moreover, setting the duration of the enable signal to be longer in the cycle of the first gating signal can ensure that the duration of the enable signal of the light-emitting control signal PAM-EM output by the first shift register unit 10a is longer, and thus the duration of one single light-emitting stage is ensured to be longer when driving the pixel circuit 30 to operate.

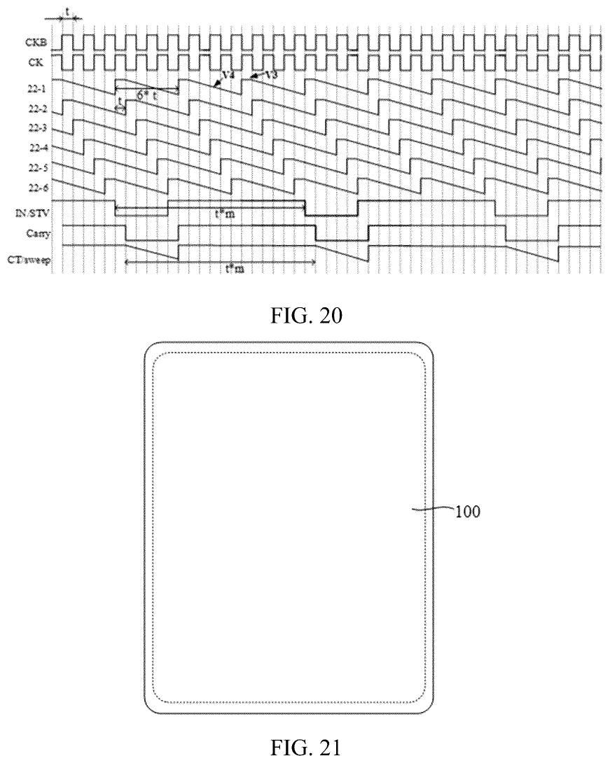

In some implementations, FIG. 20 is another signal timing diagram according to an embodiment of the present disclosure, and the shift register unit 10 provided in the embodiment of FIG. 18 can be driven by using the signal timing provided in FIG. 20. The shift register unit 10 provided in the embodiment of FIG. 18 can serve as the second shift register unit 10b in the embodiment of FIG. 8. For understanding, refer to FIGS. 8 and 18. FIG. 20 takes n=6 as an example, 6 second gating signal lines 22 are arranged in the display panel, and the second gating signal lines 22 are connected to the second shift register units 10b. The 6 second gating signal lines 22 are respectively the second gating signal line 22-1 to the second gating signal line 22-6. The signals provided by the second gating signal lines 22 include a periodic ramp signal.

It can be seen from FIG. 20 that when the pulse cycle of the trigger signal STV received by the driving module 11 in the first stage second shift register unit 10b is set to t*m in the operating mode of the display panel, the pulse cycle of the control signal CT output by the second shift register unit 10b is t*m. The control signal CT can serve as the sweep signal sweep for driving the pixel circuit 30 to operate, and using the signal timing provided in the embodiment of FIG. 20 can drive the pixel circuit 30 to operate such that the time interval between two adjacent light-emitting stages t5 in which the pixel circuit row 30H operates is t*m.

In addition, FIG. 20 is illustrated with n=6. It can be seen from FIG. 20 that the gating signals are output by the second gating signal line 22-1 to the second gating signal line 22-6 respectively, and the cycle of the second gating signal line 22 providing the gating signal is n*t, and the difference between the cycle start moments of the gating signals provided by two adjacent second gating signal lines 22 arranged in sequence is t. Such a setting can realize that the plurality of gating modules 12 in the plurality of second shift register units 10b are controlled to sequentially output the sweep signals by using the n second gating signal lines 22, so as to realize the driving of the plurality of pixel circuit rows 30H row by row.

As shown in FIG. 20, the second gating signal line 22 provides the second gating signal, and the cycle of the second gating signal is n*t; the second gating signal includes a constant voltage signal V3 and a ramp signal V4; and in one cycle of the second gating signal, the duration of the ramp signal V4 is greater than the duration of the constant voltage signal V3. In the embodiment of the present disclosure, setting the cycle of the second gating signal to n*t can realize that the plurality of gating modules 12 in the plurality of second shift register units 10b are controlled to sequentially output the control signals by using the n second gating signal lines 22, so as to realize the driving of the plurality of pixel circuit rows 30H row by row. Moreover, setting the duration of the ramp signal V4 to be longer in the cycle of the second gating signal can ensure that the duration of the ramp signal in the sweep signal sweep output by the second shift register unit 10b is longer, and thus the sweep signal sweep can cooperate with the duration of the light-emitting stage to regulate and control the actual light-emitting duration of the light-emitting device PD.

Based on the same inventive concept, an embodiment of the present disclosure further provides a display apparatus, and FIG. 21 is a schematic diagram of a display apparatus according to an embodiment of the present disclosure. As shown in FIG. 21, the display apparatus includes the display panel 100 according to any of the embodiments of the present disclosure. The structure of the display panel 100 has been described in the above-mentioned embodiments, and will not be repeated herein. The display apparatus according to the embodiment of the present disclosure may be an electric device having a display function, such as a mobile phone, a tablet, a computer, a television, and a smart wearable device.

The above are only preferred embodiments of the present disclosure and are not intended to limit the present disclosure, and any modifications, equivalent substitutions, improvements and the like made within the spirit and principle of the present disclosure should be included within the scope of protection of the present disclosure.

Finally, it should be noted that the above embodiments are merely used to illustrate the technical solutions of the present disclosure, but not to limit the same. Although the present disclosure has been described in detail with reference to the above embodiments, those of skill in the art should understand that they can still modify the technical solutions recited in the above embodiments, or perform equivalent substitution of some or all of the technical features therein; and these modifications or substitutions do not cause the essence of the corresponding technical solutions to depart from the scope of the technical solutions of the embodiments of the present disclosure.

What is claimed is:

1. A display panel, comprising: a plurality of shift register units, n gating signal lines, and N pixel circuit rows, where n and N are both positive integers;
wherein a pixel circuit row of the N pixel circuit rows comprises a plurality of pixel circuits arranged in a same direction;
the plurality of shift register units are cascaded, a shift register unit of the plurality of shift register units comprises a driving module and a gating module, and one control terminal of the gating module is connected to an output terminal of the driving module; an output terminal of the driving module in an i-th shift register unit is connected to one input terminal of the driving module in an (i+1)-th shift register unit, where i is a positive integer; the gating module is configured to receive at least a signal output by a corresponding driving module and a signal provided by a corresponding gating signal line, and output a control signal; and an output terminal of the gating module is connected to the plurality of pixel circuits in at least one of the pixel circuit rows;
the n gating signal lines comprise a 1st gating signal line, a 2nd gating signal line, . . . , to an n-th gating signal line arranged in sequence, and the n gating signal lines are alternately connected to the gating modules in the plurality of shift register units; and
an operating mode of the display panel comprises:
the pixel circuit row comprises at least two light-emitting stages within a first time, wherein a duration of the first time is equal to a duration of one frame time, and a time interval between two adjacent light-emitting stages is t*m, where t is row time, and m is a coefficient; and t=T/N, where T is one frame time, m is a positive integer, and m>n.

2. The display panel according to claim 1, wherein
N is an integer multiple of m; or
N+r is an integer multiple of m, where r is an integer.

3. The display panel according to claim 1, wherein
the output terminal of the gating module is connected to k pixel circuit rows, where k is an integer and k≥1; and
m is an integer multiple of k*n.

4. The display panel according to claim 1, wherein
the pixel circuit row comprises w light-emitting stages within the first time, wherein w=N/m; or w=(N+r)/m, where r is an integer.

5. The display panel according to claim 1, wherein
the output terminal of the gating module is connected to k pixel circuit rows, where k is an integer and k≥1; and
a duration of a light-emitting stage of the at least two light-emitting stages is Z, and Z≤k*t*n.

6. The display panel according to claim 1, wherein
durations of the light-emitting stages of the pixel circuit row within the first time are equal.

7. The display panel according to claim 1, wherein
the operating mode of the display panel comprises a first mode and a second mode, a brightness of the display panel in the first mode is less than a brightness of the display panel in the second mode;
the coefficient comprises a first coefficient m₁ and a second coefficient m₂;
in the first mode, the pixel circuit row comprises at least two light-emitting stages within the first time, and the time interval between two adjacent light-emitting stages is t*m₁; and
in the second mode, the pixel circuit row comprises at least two light-emitting stages within the first time, and the time interval between two adjacent light-emitting stages is t*m₂; and
wherein m₁>m₂.

8. The display panel according to claim 1, wherein
the operating mode of the display panel comprises:
during display of one frame, sequentially driving the N pixel circuit rows; and
during display of two consecutive frames, a time interval between start moments of two times of driving of a first pixel circuit row is T.

9. The display panel according to claim 1, wherein
N is an integer multiple of m; and
the operating mode of the display panel comprises: at a start moment of a light-emitting stage of the at least two light-emitting stages of the pixel circuit row, a number of the pixel circuit rows driven by the n gating signal lines through the gating modules to be in the light-emitting stage is equal.

10. The display panel according to claim 1, wherein
N+r is an integer multiple of m, where r is an integer;
at a start moment of a light-emitting stage of the at least two light-emitting stages of the pixel circuit row, numbers of the pixel circuit rows driven by different gating signal lines through the gating modules to be in the light-emitting stage differ by at most 1.

11. The display panel according to claim 1, wherein
the operating mode of the display panel comprises: the control signal comprises at least two cycles within the first time, and a cycle of the control signal is t*m.

12. The display panel according to claim 1, wherein
the operating mode of the display panel comprises: a pulse cycle of a trigger signal received by the driving module in a first shift register unit is t*m.

13. The display panel according to claim 1, wherein
the operating mode of the display panel comprises:
the gating signal lines provide gating signals, a cycle of the gating signals is n*t, a difference between start moments of cycles of the gating signals provided by two adjacent gating signal lines arranged in sequence is t.

14. The display panel according to claim 1, wherein
the pixel circuit comprises a first driving circuit and a second driving circuit, the first driving circuit is configured to control an amplitude of a driving current supplied to a light-emitting device based on a first data voltage, and the second driving circuit is configured to control a duration of the driving current supplied to the light-emitting device based on a second data voltage and a sweep signal.

15. The display panel according to claim 14, wherein
the first driving circuit comprises a first driving transistor, a first control transistor and a second control transistor, and the first driving transistor is connected in series between the first control transistor and the second control transistor;
the shift register units comprise first shift register units, the gating signal lines comprise first gating signal lines, and the first gating signal lines are connected to the first shift register units; and
the output terminal of the gating module in a first shift register unit of the first shift register units is connected to a control terminal of the first control transistor and a control terminal of the second control transistor.

16. The display panel according to claim 15, wherein
the first gating signal lines provide first gating signals, and a cycle of the first gating signals is n*t;
the first gating signal comprises a first level signal and a second level signal, and the first level signal is an enable signal; and within one cycle of the first gating signal, a duration of the first level signal is longer than a duration of the second level signal.

17. The display panel according to claim 14, wherein
the shift register units comprise second shift register units, the gating signal lines comprise second gating signal lines, and the second gating signal lines are connected to the second shift register units; and
the output terminal of the gating module in a second shift register unit of the second shift register units is connected to the second driving circuit, and the control signal output by the second shift register unit is the sweep signal.

18. The display panel according to claim 17, wherein
the second gating signal lines provide second gating signals, and a cycle of the second gating signals is n*t; and
the second gating signal comprises a constant voltage signal and a ramp signal; and within one cycle of the second gating signal, a duration of the ramp signal is longer than a duration of the constant voltage signal.

19. The display panel according to claim 1, wherein n=6.

20. A display apparatus, comprising a display panel, wherein the display panel comprises: a plurality of shift register units, n gating signal lines, and N pixel circuit rows, where n and N are both positive integers;
wherein a pixel circuit row of the N pixel circuit rows comprises a plurality of pixel circuits arranged in a same direction;
the plurality of shift register units are cascaded, a shift register unit of the plurality of shift register units comprises a driving module and a gating module, and one control terminal of the gating module is connected to an output terminal of the driving module; an output terminal of the driving module in an i-th shift register unit is connected to one input terminal of the driving module in an (i+1)-th shift register unit, where i is a positive integer; the gating module is configured to receive at least a signal output by a corresponding driving module and a signal provided by a corresponding gating signal line, and output a control signal; and an output terminal of the gating module is connected to the plurality of pixel circuits in at least one of the pixel circuit rows;
the n gating signal lines comprise a 1st gating signal line, a 2nd gating signal line, . . . , to an n-th gating signal line arranged in sequence, and the n gating signal lines are alternately connected to the gating modules in the plurality of shift register units; and
an operating mode of the display panel comprises:
the pixel circuit row comprises at least two light-emitting stages within a first time, wherein a duration of the first time is equal to a duration of one frame time, and a time interval between two adjacent light-emitting stages is t*m, where t is row time, and m is a coefficient; and t=T/N, where T is one frame time, m is a positive integer, and m>n.
